(19) United States
(12) Patent Application Publication
(10) Pub. No.: US 2016/0041404 A1
(43) Pub. Date: Feb. 11, 2016

(54) EYEWEAR WITH INTERCHANGEABLE TEMPLES AND BROW BAR

(71) Applicant: MARCHON EYEWEAR, INC., Melville, NY (US)

(72) Inventors: Antonio Palermo, Belluno (IT); Annamaria Rizzato, East Northport, NY (US); Massimiliano Maccanti, Abano Terme, Padua (IT)

(21) Appl. No.: 14/455,703

(22) Filed: Aug. 8, 2014

(51) Int. Cl. G02C 5/14

(52) U.S. Cl. CPC G02C 5/14; G02C 2200/08

(57) ABSTRACT

Various embodiments are directed to eyewear that can be stylized by changing temples, brow bar and decorative beading on the temples. The eyewear comprises a frame having a first end, a second end, a top surface, a front surface and a rear surface. A first temple post is pivotally coupled to the frame first end. A first temple comprises a first cavity formed at a first end that is configured to releasably receive the first temple post so that the first temple is coupled to the first frame end. At least one brow bar is releasably attached to at least a portion of the frame top surface, the frame front surface and the frame back surface, and at least one decorative temple portion having a hole formed there through is configured to be removably received on the first temple post intermediate the frame and the first temple.

### BACKGROUND

Users choose eyewear frames to match their personality and style. However, the style of any one particular eyewear is fixed and cannot generally be changed to match the day-to-day style and personality changes of the user. Various embodiments of the present eyewear recognize and address the foregoing considerations, and others, of prior art eyewear.

### SUMMARY

Eyewear, in various embodiments, is configured to support one or more lenses. The eyewear comprises a frame having a first end, a second end, a top surface, a front surface and a rear surface. A first temple post is pivotally coupled to the frame first end and a second temple post is pivotally coupled to the frame second end. A first temple comprises a first cavity formed at a first end that is configured to releasably receive the first temple post so that the first temple is coupled to the first temple post until a sufficient axial force is exerted on the temple. Furthermore, a second temple comprising a second cavity formed at a first end, the second cavity being configured to releasably receive the second temple post so that the second temple is coupled to the second temple post until a sufficient axial force is exerted on the temple.

In various embodiments, the first temple is releasably coupled to the first temple post and the second temple is releasably attached to the second temple post by a connection selected from a group consisting of a friction fit, a spring loaded ball and catch, by a spring loaded pin and catch, and by a spring tab and catch. In some of these embodiments, the friction fit is formed by a raised detent formed on one of the first temple post and the first temple and a catch formed on the other of the first temple post and the first temple.

In various embodiments, the first temple further comprises a first opening formed in a side of the first temple such that the first opening opens into the first cavity and is configured to receive a portion of the first temple post therein. In various embodiments, the first temple post further comprises an elongated body having at least one flange that extends substantially perpendicular from the surface of the elongated body. In some of these embodiments, the at least one flange is at least partially received in the first temple first opening.

In certain embodiments, the eyewear further comprises at least one brow bar that is releasably attached to at least a portion of the frame top surface, the frame front surface and the frame back surface. In some embodiments, the at least one brow bar extends from the frame first end to the frame second end. In various embodiments, the at least one brow bar defines a cavity therein that is configured to releasably receive at least the top surface of the frame therein. In certain embodiments, one of the frame front surface and a wall of the at least one brow bar cavity has at least one raised detent formed thereon to create a friction connection between the at least one brow bar and the frame. In some of these embodiments, the other of the frame front surface and the wall of the at least one brow bar cavity has a respective catch formed therein that aligns with, and at least partially receives, the raised detent. In particular embodiments, the at least one raised detent is a substantially convex hemispherical shaped raised area. In still other embodiments, the at least one brow bar comprises a first brow bar having a first end that is positioned adjacent to the frame first end and a second end that is positioned proximate to a nose portion of the frame, and a second brow bar having a first end proximate to the nose portion and a second end adjacent to the frame second end. In some embodiments, the first and second brow bars are attached to the frame by a friction attachment.

In yet other embodiments, the eyewear further comprises at least one decorative temple portion having a hole formed there through and is configured to be removably received on the first temple post intermediate the frame and the first temple. In some of these embodiments, the at least one decorative temple portion is substantially polygonal in shape.

In other embodiments, eyewear is configured to support one or more lenses and comprises a frame having a first end, a second end, a top surface, a front surface and a rear surface. A first temple post is pivotally coupled to the frame first end and a second temple post is pivotally coupled to the frame second end. A first temple comprises a first cavity formed at a first end that is configured to releasably receive the first temple post so that the first temple is coupled to the first temple post until a sufficient axial force is exerted on the temple. Moreover, a second temple comprises a second cavity formed at a first end that is configured to releasably receive the second temple post so that the second temple is coupled to the second temple post until a sufficient axial force is exerted on the temple. Finally, at least one brow bar is releasably attached to at least a portion of the frame top surface, the frame front surface and the frame back surface.

In yet other embodiments of eyewear, the eyewear is configured to support one or more lenses and comprises a frame having a first end, a second end, a top surface, a front surface and a rear surface. A first temple post is pivotally coupled to the frame first end and a second temple post is pivotally coupled to the frame second end. A first temple comprises a first cavity formed at a first end that is configured to releasably receive the first temple post so that the first temple is coupled to the first temple post by at least frictional force. A second temple comprises a second cavity formed at a first end and is configured to releasably receive the second temple post so that the second temple is coupled to the second temple post by at least frictional force. At least one decorative temple portion having a hole formed there through is configured to be removably received on the first temple post intermediate the frame and the first temple.

### BRIEF DESCRIPTION OF THE DRAWINGS

Various embodiments of eyewear with interchangeable temples and top bar are described below. In the course of this description, reference will be made to the accompanying drawings, which are not necessarily drawn to scale, and wherein:

FIG. 1 is a front perspective view of an embodiment of eyewear with interchangeable temples attached;

FIG. 2 is a front perspective view of the eyewear of FIG. 1 without the interchangeable temples attached;

FIG. 3 is a rear perspective view of the eyewear of FIG. 2;

FIG. 4 is a perspective view of the eyewear of FIG. 2;

FIG. 5 is a partial top view of the eyewear of FIG. 2;

FIG. 6 is a partial rear perspective view of the eyewear of FIG. 2;

FIG. 7 is a perspective view of the eyewear of FIG. 1;

FIG. 8 is a partial side view of the temple shown in FIG. 7;

FIG. 9 is a partial side view of the eyewear of FIG. 1;

FIG. 10 is a front perspective view of the eyewear of FIG. 1 having a double brow bar installed on the eyewear;

FIG. 11 is a partial bottom view of the double brow bar of FIG. 10;

FIG. 12 is a rear view of the double brow bar of FIG. 10;

FIG. 13 is a front perspective view of the eyewear of FIG. 1 having two single brow bars installed on the eyewear, according to another embodiment;

FIG. 14 is a rear perspective view of the double brow bars of FIG. 13;

FIG. 15 is a partial exploded perspective view of an embodiment of eyewear;

FIG. 16A is a partial bottom view of a temple post of the eyewear of FIG. 15;

FIG. 16B is a partial rear view of the temple post of FIG. 16A;

FIG. 17 is a partial side view of the temple post of FIG. 16A; and

FIG. 18 is a perspective view of the eyewear of FIG. 15.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Eyewear

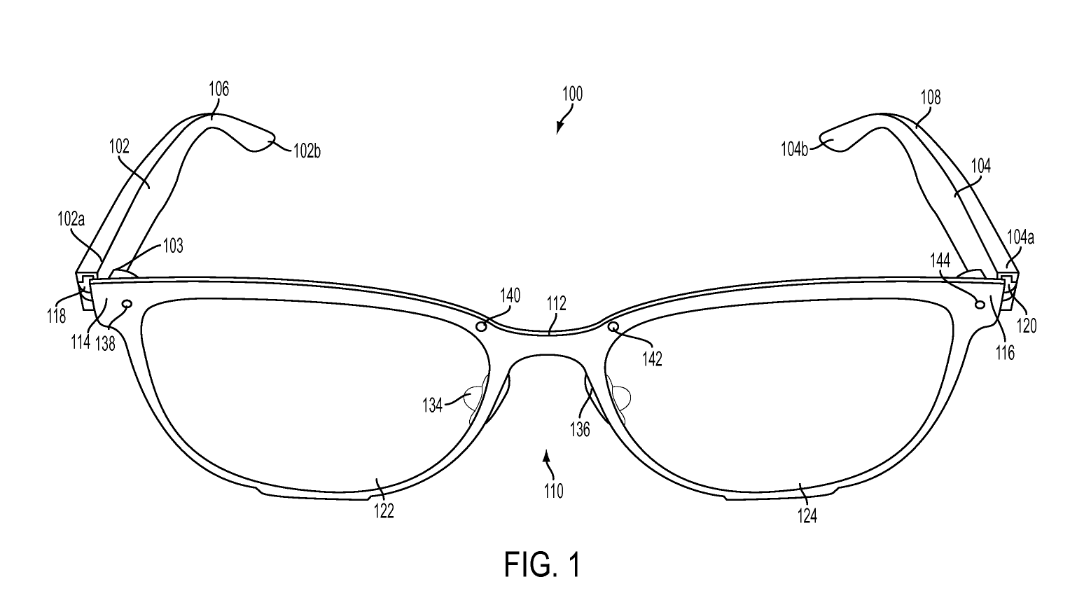

As shown in FIG. 1, eyewear 100, according to various embodiments, includes: (1) an eyewear frame 110; (2) a first temple post 118; (3) a second temple post 120; (4) a first temple 102; and (5) a second temple 104. These various components are discussed in more detail below.

### Eyewear Frame

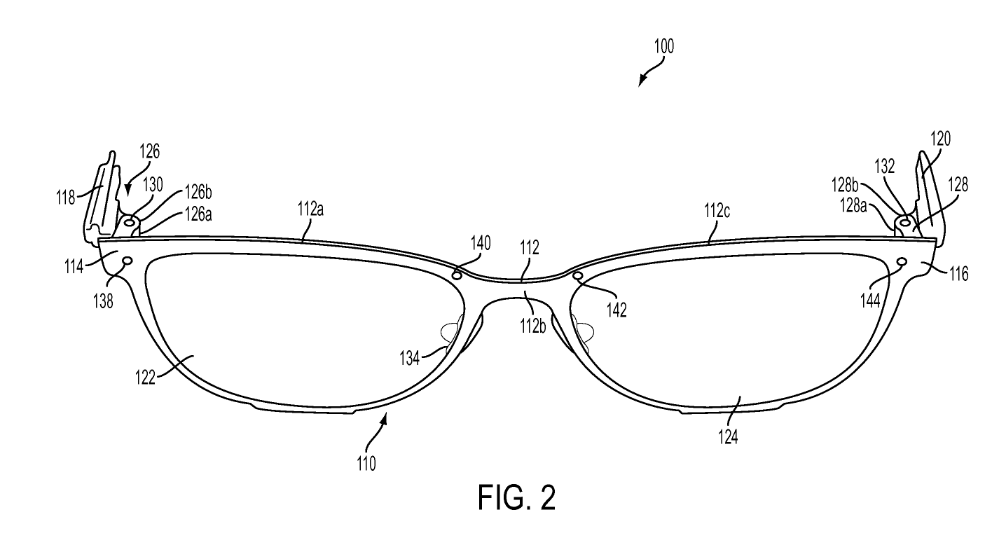

Referring to FIG. 2, eyewear 100, in various embodiments, includes any suitable eyewear frame 110 configured to support one or more lenses 122, 124. In the embodiment shown in this figure, the eyewear frame 110 has a first end 114 and a second end 116 and defines a top surface 112. The top surface 112 has a first portion 112a, a middle portion or bridge 112b, and a second portion 112c. The eyewear frame 110 may be made of any suitable material such as metal, ceramic, polymers or any combination thereof. In particular embodiments, the eyewear frame 110 is configured to support the first and second lenses 122, 124 about the full perimeter of the first and second lenses 122, 124. In other embodiments, the eyewear frame 110 may be configured to support the first and second lenses 122, 124 at least partially around a portion of each respective lens. In various embodiments, the eyewear frame 110 is configured to support a number of lenses other than two lenses (e.g., a single lens, a plurality of lenses, etc.). In particular embodiments, the first and second lenses 122, 124 may include prescription lenses, sunglass lenses, or any other suitable type of lens (e.g., reading lenses, non-prescription lenses), which may be formed from glass, polymers, or other suitable material.

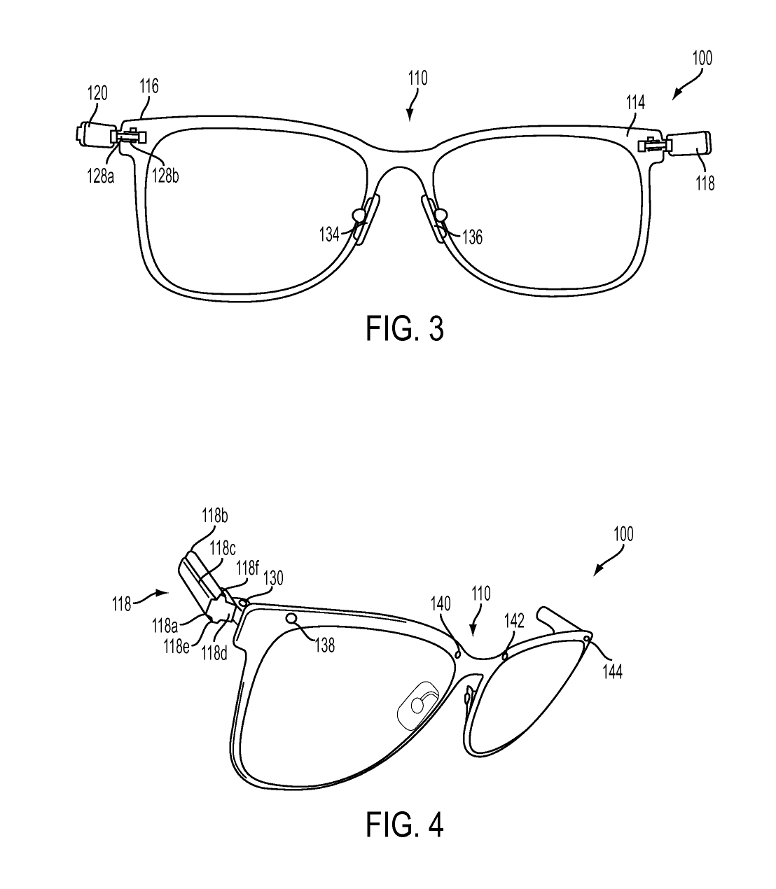

In the embodiment shown in FIGS. 2 and 3, the eyewear frame 110 includes a first and second nose pad 134, 136, which may be configured to maintain the eyewear 100 adjacent the front of a wearer's face such that the lenses 122, 124 are positioned substantially in front of the wearer's eyes while the wearer is wearing the eyewear 100. In particular embodiments, the nose pads may comprise a material that is configured to be comfortable when worn by the wearer (e.g., rubber, etc.). In other embodiments, the nose pads may include any other suitable material (e.g., plastic, metal, etc.). In still other embodiments, the nose pads may be integrally formed with the frame.

Referring again to FIG. 2, the eyewear frame 110 includes a first and second hinge 126, 128, that attach the first and second temple posts 118, 120 to the frame first and second ends 114, 116, respectively. The hinges 126, 128 are formed by a tongue 126a, 128a formed on the respective temple posts 118, 120, and a groove 126b, 128b formed on the respective first and second ends 114, 116 of the frame. Each tongue 126a, 128a is coupled in its respective groove 126b, 128b, using fasteners 130, 132, which may be any suitable fastener (e.g., a screw, a bolt, a pin, a rivet, weldments, etc.). In various embodiments, the hinges may be formed by any suitable connection (e.g., ball and socket, spring hinge, etc.). The grooves 126b, 128b may be welded to, or integrally formed with, the eyewear frame 110, and the tongues 126a, 128a may be welded to, or integrally formed with, the temple posts 118, 120 or may be integrally formed with the eyewear frame 110 and temple posts 118, 120. In various embodiments, the hinges 126, 128 can be formed by any suitable connection means.

A first raised convex hemispherical shaped detent 138, a second raised convex hemispherical shaped detent 140, a third raised convex hemispherical shaped detent 142, and a fourth raised convex hemispherical shaped detent 144 are positioned along the frame top surface 112 intermediate to the frame first end 114 and the frame second end 116. The first and fourth raised convex hemispherical shaped detents 138, 144 are positioned adjacent to the frame first and second ends 114, 116 respectively, while the second and third raised convex hemispherical shaped detents 140, 142 are positioned on either side of the bridge 112b. In various embodiments, the frame may include any number of raised convex hemispherical shaped detents. In other embodiments, the raised convex hemispherical shaped detents may be formed at any point along the frame top surface 112. In yet other embodiments, the raised convex hemispherical shaped detents may be formed in any shape and may be either concave or convex with respect to the frame top surface 112. In addition, the raised convex hemispherical shaped detents may be formed on the front (or outer surface) of the frame, as shown in the present embodiment in FIG. 2, and/or the raised convex hemispherical shaped detents may be formed on the rear (or inner) surface of the frame so that the raised convex hemispherical shaped detents are positioned adjacent to the wearer's face when the eyewear 100 is worn. In various other embodiments, the raised convex hemispherical detents may also be formed on both the front and rear surface of the frames.

### First Temple Post

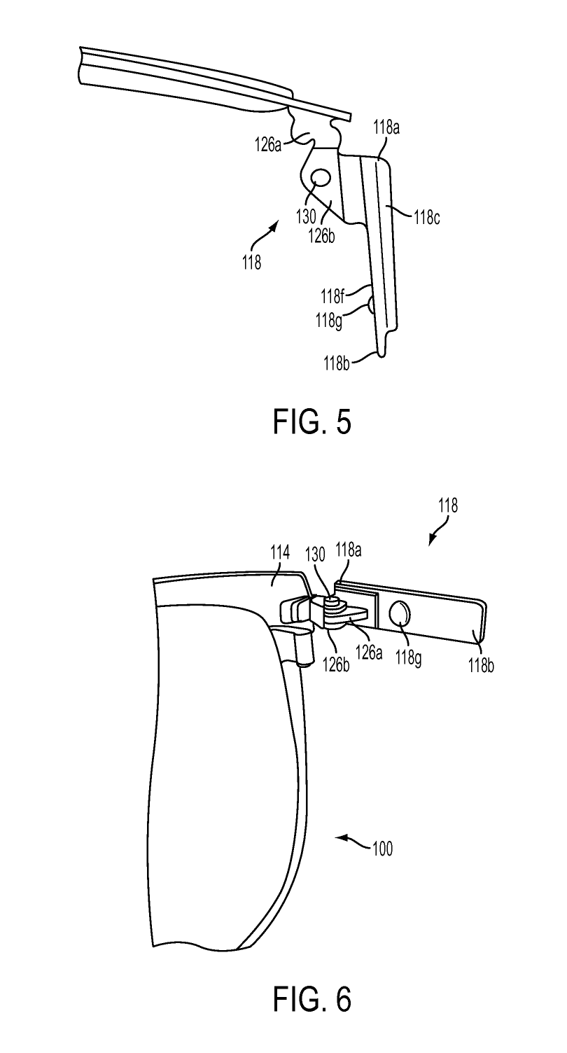

As shown in FIGS. 4 through 5, the first temple post 118, according to various embodiments, is pivotally coupled to the frame 110 at a right angle so that the first temple post 118 extends substantially perpendicular, substantially parallel, or anywhere in between substantially perpendicular and substantially parallel to the frame 110. The first temple post 118 has a first and second end 118a, 118b. The first temple post cross-section is substantially t-shaped. That is, the first temple post 118 has a raised generally rectangular middle portion 118c formed on a general rectangular base portion 118d that is larger than the raised middle portion 118c so that first and second flanges 118e and 118f are formed along a substantial length of the first temple post 118. In various embodiments, the raised middle portion 118c does not extend the entire length of the first temple post 118, but rather ends before reaching the first temple post second end 118b, as shown in FIG. 5, leaving a portion of the base portion 118d at the first temple post second end 118b. In the present embodiment, the first temple post raised middle portion 118c is substantially rectangular, however, in various embodiments, the raised middle portion may be formed in any suitable shape. In various embodiments, the temple post cross-section may be formed in any suitable shape (e.g., round, rectangular, square, etc.)

Referring briefly to FIG. 6, the first temple post 118 has a first raised convex hemispherical shaped detent intermediate the first temple post first and second ends 118a, 118b. In various embodiments, the first temple post may include any number of raised convex hemispherical shaped detents along the length of the first temple post 118. In other embodiments, the raised convex hemispherical shaped detent may be formed at any point along the first temple post 118. In various embodiments, the raised convex hemispherical shaped detents may be formed in any shape and may be either concave or convex with respect to a back surface of the first temple post 118. In addition, the raised convex hemispherical shaped detents may be formed on the inner (back) surface of the first temple post 118, as shown in the present embodiment in FIG. 5, or may be formed on the outer (front) surface of the first temple post 118 in the position presently held by the first temple post raised middle portion 118c.

### First Temple

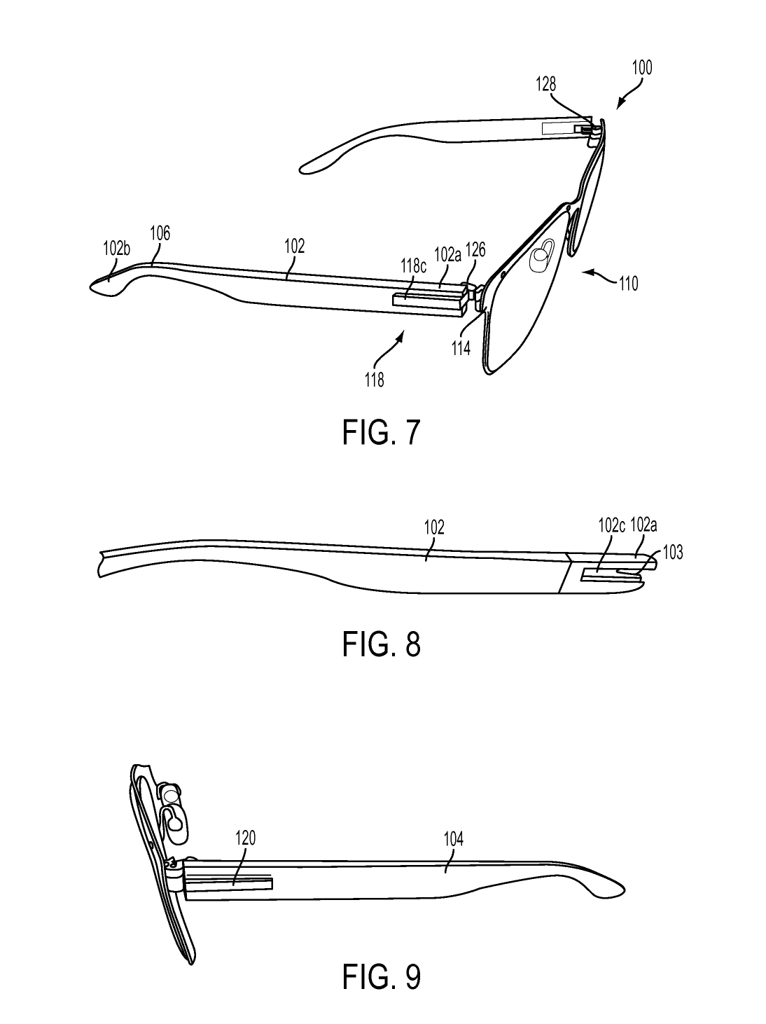

Referring to FIG. 7, the first temple 102 has a first and second end 102a, 102b. Proximate the first temple second end 102b, the first temple 102 includes an earpiece 106 configured to be supported by a wearer's ear. The first temple 102 extends substantially rearward from the eyewear frame 110 adjacent the eyewear frame first side 114. In the embodiment shown in these figures, the first temple first end 102a is slidably mounted to the first temple post 118, as explained herein.

Referring briefly to FIG. 8, the first temple 102 has an opening 102c formed therein proximate the first end 102a. The first temple opening 102c is configured to receive the first temple post 118 (FIG. 7) so that the first temple 102 is slidably mounted to the first temple post 118. That is, the first temple opening 102c and the first temple post 118 are both substantially the same shape (e.g., T-Shaped), where the first temple opening 102c is slightly larger than the first temple post 118 and is retained thereon by interaction of the raised convex hemispherical shaped detent 118g formed on the first temple post 118 and a corresponding detent formed in a wall of the first temple opening 102c. The opening also is configured to allow the outer surface of the first temple post raised portion 118c to extend through the first temple opening so that the raised portion 118c functions as a decorative accent to the temple. The first temple 102 also has a second opening 103 formed on the opposite side of the first temple hole adjacent the first temple first end 102a that is configured for receiving the first hinge 126, as shown in FIG. 1.

### Second Temple Post and Second Temple

Referring again to FIGS. 1 and 2, the second temple post 120 and the second temple 104 substantially mirror the first temple post 118 and the first temple 102. Thus, for purposes of ease of understanding and clarity, only certain parts will be discussed to highlight the differences in the structure and operation of the embodiment shown in FIGS. 1-9. As shown in FIG. 2, the second temple post 120 is adjacent the frame second side 116 and substantially parallel the first temple post 118. The second temple post 120 extends substantially rearward from the eyewear frame 110 adjacent the frame second side 116. As shown in FIG. 9, similar to the first temple 102, the second temple 104 is slidably mounted to the second temple post 120.

### Double Brow Bar

Referring to FIG. 11, a double brow bar 150 is slidably mounted to the frame top surface 112 from the frame first end 114 to the frame second end 116, using a tongue and groove relationship between the double brow bar 150 (i.e., the groove) and the frame top surface first end 112a, the bridge 112b, and the frame top surface second end 112c (FIG. 2). The double brow bar 150 has a first end 150a adjacent the first temple 102 and a second end 150b adjacent the second temple 104.

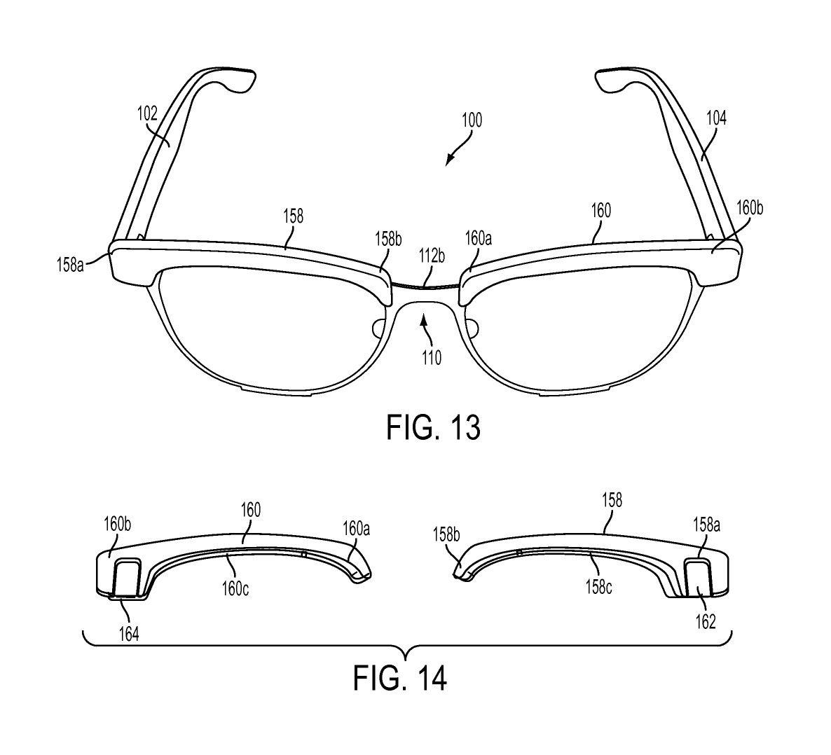

Referring to FIGS. 12 and 13, a groove 152 (FIG. 11) runs the length of the double brow bar 150 from the double brow bar first end 150a to the second end 150b. The double brow bar 150 also has a first opening 154 and a second opening 156 for receiving a portion of the first and second hinges 126, 128, respectively (e.g., FIG. 7). When the frame top surfaces 112a, 112b and 112c (FIG. 2) are slid into the double brow bar groove 152, the raised convex hemispherical shaped detents 138, 140, 142, 144 (FIG. 2) on the frame are received in corresponding detents (e.g., semi-spherical recesses only two being shown in the figures) 154a, 156a formed in the double brow bar groove 152, which retains the double brow bar 150 on the frame top surfaces 112a, 112b and 112c by preventing the double brow bar 150 from being removed without force.

### Single Brow Bars

Referring to FIG. 13, a first and a second single brow bar 158, 160 are slidably mounted to the frame top surfaces 112a and 112c leaving the bridge 112b uncovered. The first single brow bar 158 has a first and second end 158a, 158b. The first end 158a is proximate the first temple 102, while the second end 158b is proximate the bridge 112b. Similarly, the second single brow bar 160 has a first end 160a proximate the bridge 112b and a second end 160b proximate the second temple 104.

Referring to FIG. 14, similar to the double brow bar 150, the first single brow bar 158 has a first groove 158c and the second single brow bar 160 has a second groove 160c for respectively receiving the frame top surface first and second portions 112a, 112c. The first and second single brow bars 158, 160 also have a first opening 162 and a second opening 164 for receiving a portion of the first and second hinges 126, 128, respectively. Thus, when the frame top surface first and second portions 112a, 112c are slid into the respective first and second single brow bar grooves 158c, 160c, the raised convex hemispherical shaped detents 138, 140, 142, 144 are received in respective catches (concave recesses shown, but not numbered) formed in the walls defining the grooves 158c, 160c, which thereby retains the position of the single brow bars 158, 160 on the eyewear frame 112 by preventing the single brow bars 158, 160 from being removed without force.

### Alternate Embodiment

### Temple and Temple Post Alternate Embodiment

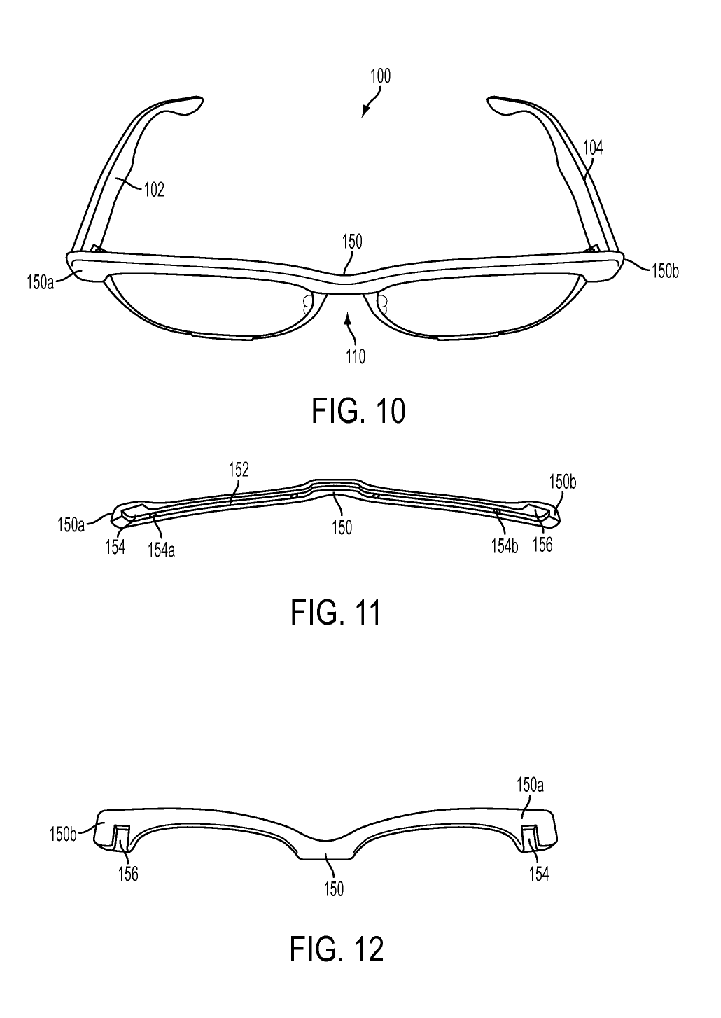

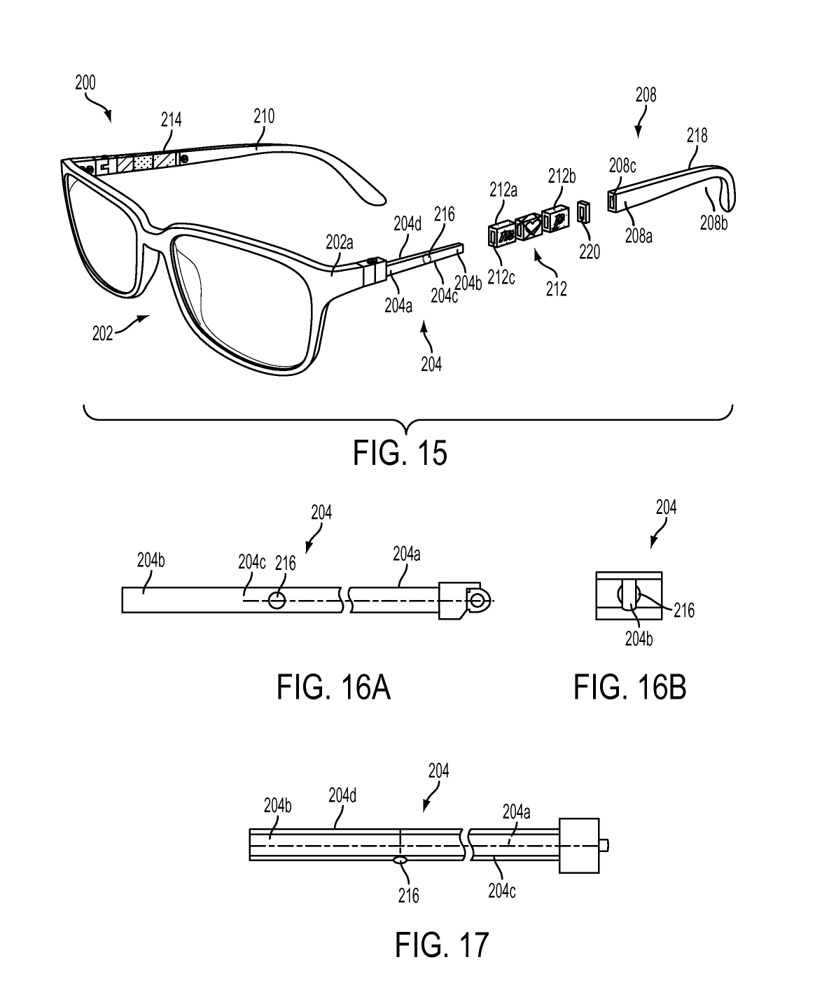

FIGS. 15-18 illustrate an alternative embodiment of eyewear 200 that is similar to the eyewear 100 of FIGS. 1-14. For purposes of ease of understanding and clarity, only certain parts will be discussed to highlight the differences in the structure and operation of the embodiment shown in FIGS. 15-18 as compared to the embodiments shown in FIGS. 1-14. As shown in FIG. 15, eyewear 200, according to various embodiments, includes: (1) an eyewear frame 202; (2) a first temple post 204; (3) a second temple post 206 (not shown); (4) a first temple 208; (5) a second temple 210; (6) a first decorative temple portion 212; and (7) a second decorative temple portion 214. These various components are discussed in more detail below.

In this embodiment, the first and second temple posts 118, 120 shown in FIGS. 1-14 are replaced with a first and second temple post 204, 206 that are generally rectangular in shape, with a flat inner and outer surface with respect to the wearer's face when the eyewear 200 is worn. The second temple post 206, the second temple 210, and the second decorative temple portion 214 substantially mirror the first temple post 204, the first temple 208, and the first decorative temple portion 212. Thus, for purposes of brevity, only the first temple post 204, the first temple 208, and the first decorative temple portion 212 will be discussed to highlight the differences in the structure and operation of the embodiments shown in FIGS. 15-19 as compared to the embodiments shown in FIGS. 1-14.

### First Temple Post

As shown in FIG. 15, the first temple post 204, according to various embodiments, is pivotally coupled to the eyewear frame 202 at a right angle so that the first temple post 204 extends substantially perpendicular, substantially parallel, or anywhere in between substantially perpendicular and substantially parallel to the eyewear frame 202. The first temple post 204 has a first and second end 204a, 204b, a bottom surface 204c and a top surface 204d. The cross-section of the first temple post 204 is substantially rectangular (FIG. 16B). In various embodiments, the first temple post may be formed in any suitable shape (e.g., cylindrical, pyramidal, polygonal, etc.). The first temple post 204 extends substantially rearward from the eyewear frame 202 adjacent an eyewear frame first side 202a toward the first temple 208.

Referring briefly to FIGS. 16A, 16B and 17, the first temple post 204 has a first convex hemispherical shaped detent 216 intermediate the first temple post first and second ends 204a, 204b positioned on the first temple post bottom surface 204c. In various embodiments, the first temple post may include any number of raised convex hemispherical shaped detents along the length of the first temple post. In other embodiments, the convex hemispherical shaped detent may be formed at any point along the first temple post 204. In various embodiments, the convex hemispherical shaped detent may be formed in any shape and may be either concave or convex with respect to a surface of the first temple post 204. In addition, the convex hemispherical shaped detent may be formed on any surface of the first temple post 204, including the top surface 204d, the front (or outer) surface of the frame, or on the rear (or inner) surface of the frame so that the convex hemispherical shaped detent is positioned adjacent to the wearer's face when the eyewear 200 is worn. In other embodiments, the convex hemispherical shaped raised detent 216 may be formed on the temple.

### First Temple

Referring again to FIG. 15, the first temple 208 has a first and second end 208a, 208b. Proximate the first temple second end 208b, the first temple 208 includes an earpiece 218 configured to be supported by a wearer's ear. The first temple 208 extends substantially rearward from the eyewear frame 202 adjacent the eyewear frame first side 202a. In the embodiment shown in these figures, the first temple first end 208a is slidably mounted to the first temple post 204, as explained herein.

The first temple 208 has an opening 208c formed therein proximate the first end 208a. The first temple opening 208c is configured to receive the first temple post 204 so that the first temple 208 is releasably mounted to the first temple post 204. That is, the first temple opening 208c and the first temple post 204 are both substantially the same shape (e.g., rectangular), where the first temple opening 208c is slightly larger than the first temple post 204 and is retained thereon by interaction of the convex hemispherical shaped raised detent 216 formed on the first temple post 204 and a corresponding catch formed in a wall of the first temple opening 208c. In various embodiments, the first temple 208 may be coupled to the first temple post 204 in any suitable manner (e.g., a bolt, a pin, a rivet, a cotter pin, weldments, etc.). In various embodiments, the first temple 208 does not contain a corresponding catch and the first temple 208 is retained on the first temple post 204 by a friction fit between the convex hemispherical shaped raised detent 216 and the wall of the first temple opening 208c. In various embodiments, other detents may be used (e.g., a spring loaded ball, a spring loaded pin, a spring tab, etc.) in place of the convex hemispherical shaped raised detent 216 so long as the other detents form a friction fit to maintain the temple on the temple post.

### First Decorative Temple Portion

Referring again to FIG. 15, the first decorative temple portion 212 has a first and second end 212a, 212b. The first decorative temple portion 212 may be made of any suitable material such as metal, ceramic, polymers or any combination thereof. Similar to the first temple 208, the first decorative temple portion 212 has an opening 212c formed therein running the length of the first decorative temple portion 212 from the first end 212a to the second end 212b. The first decorative temple portion opening 212c is configured to receive the first temple post 204 so that the first decorative temple portion 212 is slidably mounted to the first temple post 204. That is, first decorative temple portion opening 212c and the first temple post 204 are both substantially the same shape (e.g., rectangular), where the first decorative temple portion opening 212c is slightly larger than the first temple post 204 and is retained thereon by a rectangular disc 220. In various embodiments, the first decorative temple portion 212 is retained on the first temple post 204 by the first temple 208. The rectangular disc 220 is positioned intermediate the first decorative temple portion 212 and the first temple 208 and is slidably received on the first temple post 204. In present embodiments, the first decorative temple portion 212 has three substantially rectangular parts, however, in various embodiments, the first decorative temple portion may be formed in any suitable number of separate pieces (e.g., one piece, two pieces, etc.) in any suitable shape. For example, the first decorative temple portion 212 may formed in a single cylindrical shape. In addition, the first decorative temple portion 212 is interchangeable with any other suitable decorative temple portion to allow the user to change the overall style of the eyewear.

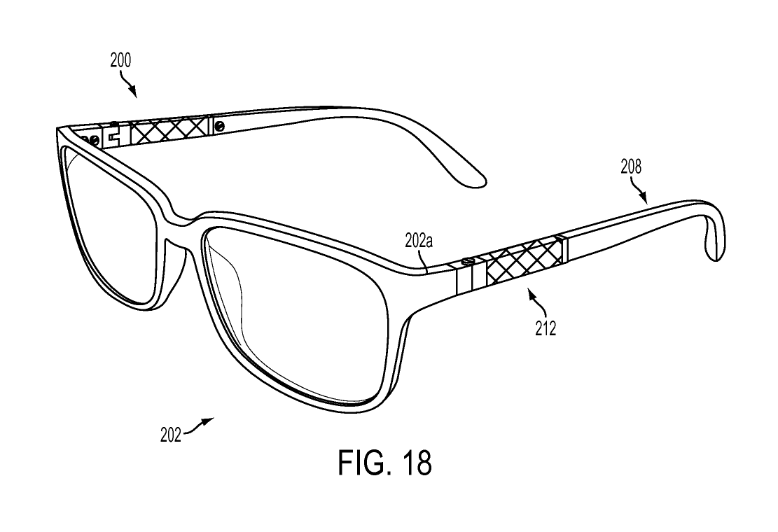

Referring to FIG. 18, the eyewear 200 is shown ready to wear by the wearer and having the first decorative temple portion 212 positioned on the first temple post 204 intermediate the eyewear frame first side 202a and the first temple 208.

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. For example, the eyewear described in these embodiments may include any other suitable eyewear, such as, for example, ski or swim goggles, sunglasses, safety goggles or glasses, etc. Therefore, it is to be understood that the invention is not to be limited to the specific embodiments disclosed herein, and that the modifications and other embodiments are intended to be included within the scope of the appended exemplary concepts. Although specific terms are employed herein, they are used in a generic and descriptive sense only and not for the purposes of limitation.

What is claimed:

1. Eyewear configured to support one or more lenses, said eyewear comprising:
a. a frame having a first end, a second end, a top surface, a front surface and a rear surface;
b. a first temple post pivotally coupled to the frame first end;
c. a second temple post pivotally coupled to the frame second end;
d. a first temple comprising a first cavity formed at a first end, the first cavity being configured to releasably receive the first temple post so that the first temple is coupled to the first temple post until a sufficient axial force is exerted on the temple; and
e. a second temple comprising a second cavity formed at a first end, the second cavity being configured to releasably receive the second temple post so that the second temple is coupled to the second temple post until a sufficient axial force is exerted on the temple.

2. The eyewear of claim 1, wherein the first temple is releasably coupled to the first temple post and the second temple is releasably attached to the second temple post by a connection selected from a group consisting of:
a. a friction fit;
b. a spring loaded ball and catch;
c. by a spring loaded pin and catch; and
d. by a spring tab and catch.

3. The eyewear of claim 2, wherein the friction fit is formed by a raised detent formed on one of the first temple post and the first temple and a catch formed on the other of the first temple post and the first temple.

4. The eyewear of claim 1, wherein the first temple further comprises a first opening formed in a side of the first temple such that the first opening opens into the first cavity, wherein the first opening is configured to receive a portion of the first temple post therein.

5. The eyewear of claim 4, wherein the first temple post further comprises an elongated body having at least one flange that extends substantially perpendicular from the surface of the elongated body.

6. The eyewear of claim 5, wherein the at least one flange is at least partially received in the first temple first opening.

7. The eyewear of claim 1, further comprising at least one brow bar that is releasably attached to at least a portion of the frame top surface, the frame front surface and the frame back surface.

8. The eyewear of claim 7, wherein the at least one brow bar extends from the frame first end to the frame second end.

9. The eyewear of claim 7, wherein the at least one brow bar defines a cavity therein that is configured to releasably receive at least the top surface of the frame therein.

10. The eyewear of claim 9, wherein one of the frame front surface and a wall of the at least one brow bar cavity has at least one raised detent formed thereon to create a friction connection between the at least one brow bar and the frame.

11. The eyewear of claim 10, wherein the other of the frame front surface and the wall of the at least one brow bar cavity has a respective catch formed therein that aligns with, and at least partially receives, the raised detent.

12. The eyewear of claim 10, wherein the at least one raised detent is a substantially convex hemispherical shaped raised area.

13. The eyewear of claim 7, wherein the at least one brow bar comprises:
a. a first brow bar having a first end that is positioned adjacent to the frame first end and a second end that is positioned proximate to a nose portion of the frame; and
b. a second brow bar having a first end proximate to the nose portion and a second end adjacent to the frame second end.

14. The eyewear of claim 13, wherein the first and second brow bars are attached to the frame by a friction attachment.

15. The eyewear of claim 1, further comprising at least one decorative temple portion having a hole formed there through, wherein the at least one decorative temple portion is configured to be removably received on the first temple post intermediate the frame and the first temple.

16. The eyewear of claim 15, wherein the at least one decorative temple portion is substantially polygonal in shape.

17. Eyewear configured to support one or more lenses, said eyewear comprising:
a. a frame having a first end, a second end, a top surface, a front surface and a rear surface;
b. a first temple post pivotally coupled to the frame first end;
c. a second temple post pivotally coupled to the frame second end; and
d. at least one brow bar that is releasably attached to at least a portion of the frame top surface, the frame front surface and the frame back surface by a friction fit;
e. a first temple comprising a first cavity formed at a first end, the first cavity being configured to releasably receive the first temple post so that the first temple is coupled to the first temple post until a sufficient axial force is exerted on the temple; and
f. a second temple comprising a second cavity formed at a first end the second cavity being configured to releasably receive the second temple post so that the second temple is coupled to the second temple post until a sufficient axial force is exerted on the temple.

18. (canceled)

19. The eyewear of claim 18, wherein the first temple is releasably coupled to the first temple post and the second temple is releasably attached to the second temple post by a friction fit.

20. The eyewear of claim 19, wherein the friction fit is formed by a raised detent formed on one of the first temple post and the first temple.

21. The eyewear of claim 20, further comprising a catch formed on the other of the first temple portion and the first temple, wherein the detent interacts with the catch to releasably retain the first temple on the first temple post.

22. The eyewear of claim 17, wherein the at least one brow bar defines a cavity therein that is configured to releasably receive at least the top surface of the frame therein.

23. The eyewear of claim 22, wherein one of the frame front surface and a wall of the at least one brow bar cavity has at least one raised detent formed thereon to create the friction fit connection between the at least one brow bar and the frame.

24. The eyewear of claim 17, wherein the at least one brow bar comprises:
a. a first brow bar having a first end that is positioned adjacent to the frame first end and a second end that is positioned proximate to a nose portion of the frame; and
b. a second brow bar having a first end proximate to the nose portion and a second end adjacent to the frame second end.

25. Eyewear configured to support one or more lenses, said eyewear comprising:
a. a frame having a first end, a second end, a top surface, a front surface and a rear surface;
b. a first temple post pivotally coupled to the frame first end;
c. a second temple post pivotally coupled to the frame second end;
d. a first temple comprising a first cavity formed at a first end, the first cavity being configured to releasably receive the first temple post via a friction fit;
e. a second temple comprising a second cavity formed at a first end, the second cavity being configured to releasably receive the second temple post via a friction fit; and
f. at least one decorative temple portion having a hole formed therethrough, wherein the at least one decorative temple portion is configured to be removably received on the first temple post intermediate the frame and the first temple.

26. The eyewear of claim 25, wherein the first temple is releasably coupled to the first temple post and the second temple is releasably attached to the second temple post by a friction fit.

27. The eyewear of claim 25, wherein the at least one decorative temple portion is substantially polygonal in shape.

28. The eyewear of claim 25, wherein the first temple is coupled to the first temple post until a sufficient axial force is exerted on the first temple and the second temple is coupled to the second temple post until a sufficient axial force is exerted on the second temple.

29. The eyewear of claim 25, further comprising at least one brow bar that is releasably attached to at least a portion of the frame top surface, the frame front surface and the frame back surface.
